(19) United States
(12) Patent Application Publication
(10) Pub. No.: US 2010/0180207 A1
(43) Pub. Date: Jul. 15, 2010

(54) SYSTEM AND METHOD FOR MANAGING AND FULFILLING CELEBRITY MEMORABILIA REQUESTS REMOTELY

(76) Inventor: Sean Michael MacGuire, Key West, FL (US)

Correspondence Address: Sean MacGuire, 1419 Atlantic Blvd #1, Key West, FL, 33040, US

(21) Appl. No.: 12/688,683

(22) Filed: Jan. 15, 2010

Related U.S. Application Data
(60) Provisional application No. 61/144,908, filed on Jan. 15, 2009.

(51) Int. Cl. G06F 3/00

(52) U.S. Cl. 715/745

(57) ABSTRACT

A system and method which allows celebrities to manage and fulfill memorabilia requests remotely including personalized audio or video greetings, simply, securely, remotely, and at the time and place of their choosing. They may also use this device to post video blog entries, video e-mail, video chat with others, or appear live.

### CROSS-REFERENCE TO RELATED APPLICATIONS

The present application claims the benefits of U.S. provisional patent application No. 61/144,908 filed Jan. 15, 2009, which is hereby incorporated by reference.

### FIELD OF THE INVENTION

The current invention relates to celebrity memorabilia, and more particularly, to a system and method for managing and fulfilling celebrity memorabilia requests remotely.

### BACKGROUND OF THE INVENTION

Probably ever since the first celebrity, there has been a market for items associated with that celebrity. Currently in the United States, this is a billion dollar market, and the memorabilia includes autographs, signed photographs or other signed items such as sports equipment, baseballs, etc.

An emerging part of this industry provides live autographs and personalized greetings from celebrities. This solves the problem of authentication for the memorabilia since the celebrity signs the memorabilia live. This usually happens at “signing events” where the celebrity appears at a given location for a “meet and greet”, and fans line up to meet their celebrity as well as to obtain a signed piece of memorabilia in exchange for a fee.

However there are drawbacks to this system, generally for the celebrity. It requires them to travel to a specific location, and deal with a large number of people for hours at a time. They may be exposed to security issues, crazed fans, increased exposure to disease from seeing so many people at close quarters, and just the dangers and inconvenience of travelling to and from the venue.

Companies like liveautograph.com have made progress by taping the celebrities at these events, or taping them while they sign various pieces of memorabilia. Similarly, meetandgreet.tv has proposed a solution where the fans are assembled over the Internet in a virtual queue where they can interact with each other, and eventually, interact virtually with the celebrity who is transmitted live from a fixed location.

Fortunately with the advance of technology and the Internet it is now feasible to use this technology to remove the need for the celebrity to be physically present at the venue. The celebrity could just ‘hook up a webcam’ to their computer and connect, but this is problematic for many reasons including but not limited to the comfort of the celebrity with the technology, the ease of use of the interface, and the availability of sufficient bandwidth. It would be also be a prime target for hackers since they'd know that the system on the other side of the video connection belonged to the celebrity, putting their privacy and even their identity at risk.

Therefore the security of the connection between the celebrity and the network, the quality of the video feed—since this is essentially the product, the ease of use, and the issue of how to manage requests for the celebrity in a sensible, timely, secure and respectful manner are essential elements in any potential solution.

However, should these issues be handled the result would likely be a happier celebrity, fulfilling requests from the comfort and intimacy of their chosen location. This would increase the quality of the memorabilia created, as well as making participation in such a system by celebrities more likely, as well as allowing celebrities to spend more time creating the memorabilia by working from home.

Therefore the need has arisen for a system and method which allows celebrities to fulfill certain memorabilia requests such as personalized greetings simply, securely, remotely, and at the time and place of their choosing.

### SUMMARY OF THE INVENTION

It is an object of the present invention to create a network of celebrities who can fulfill certain memorabilia requests remotely.

It is a further object of the present invention to allow users to make certain memorabilia requests to a celebrity in this network.

It is a further object of the present invention to allow celebrities to raise money for charity by designating all or a portion of their fees for creating memorabilia to the charity or charities of their choice.

It is a further object of the present invention that the celebrity can manage the memorabilia requests, create the requested memorabilia, review the results, and submit the memorabilia for delivery to the user making the request.

It is a further object of the present invention to allow celebrities to produce video blog entries, or video email messages to others securely.

It is a further object of the present invention to provide a means of allowing celebrities within this network to contact and communicate with each other securely if they wish.

It is a further object of the present invention to allow celebrities within the network to appear at events remotely.

Therefore, in accordance with the present invention, there is provided a method of fulfilling memorabilia requests, comprising the steps of:
(a) providing a list of celebrities, each celebrity having associated memorabilia;
(b) prompting a purchaser to request a memorabilia from one of the celebrities and to provide customization information;
(c) receiving the memorabilia request and the customization information;
(d) adding the memorabilia request to a work queue of the celebrity associated with the requested memorabilia;
(e) verifying if the requested memorabilia has been fulfilled by the associated celebrity using the provided customization information;
(f) if the memorabilia request has been fulfilled, delivering the requested memorabilia to the purchaser; and
(g) if the memorabilia request has not been fulfilled, returning to step (e).

In accordance with the present invention, there is further provided a system for fulfilling memorabilia requests, comprising:
a system user interface configured so as to:
   provide a list of celebrities, each celebrity having associated memorabilia;
   prompt a purchaser to request a listed memorabilia and to provide customization information;
a memorabilia producing device having:
   a camera;
   a device user interface including:
      a display, the display showing the memorabilia request work queue and images from the camera when activated; and
      controls for selecting a current memorabilia request from the memorabilia request work queue, activating the camera for fulfilling the current memorabilia request and providing the fulfilled memorabilia request;
a remote server in communication with the system user interface and the memorabilia producing device, the remote server being so configured so as to:
   (a) receive the memorabilia request and the customization information;
   (b) add the memorabilia request to a work queue of the celebrity associated with the requested memorabilia;
   (c) verify if the requested memorabilia has been fulfilled by the associated celebrity using the provided customization information;
   (d) if the memorabilia request has been fulfilled, deliver the requested memorabilia to the purchaser; and
   (e) if the memorabilia request has not been fulfilled, returning to step (c).

In accordance with the present invention, there is also provided a method for fulfilling memorabilia requests, comprising the steps of:
(a) providing a list of celebrities, each celebrity having at least one associated memorabilia;
(b) prompting a purchaser to request from one of the celebrities the memorabilia associated with this one celebrity;
(c) receiving the memorabilia request;
(d) having the celebrity fulfill the memorabilia request; and
(e) delivering the requested memorabilia to the purchaser.

### BRIEF DESCRIPTION OF THE DRAWINGS

The features of the invention will become more apparent in the following detailed illustrative embodiment in which reference is made to the appended drawings wherein:

FIG. 1 is a flowchart of the system.

FIG. 2 is a block diagram of user interface for ordering memorabilia.

FIG. 3 is a flowchart describing how the celebrity memorabilia producing device works.

FIG. 4 is a block diagram of the user interface of the device.

### DETAILED DESCRIPTION OF THE INVENTION

This invention allows celebrities to make money for themselves and the charities of their choice by fulfilling memorabilia requests, including personalized audio or video greetings, from the comfort and safety of their own homes, or any other preferred location.

This invention is an important enhancement in celebrity memorabilia since it allows celebrities to be present by video in either real time, or as video clips. In the case of video clips, they control the production and quality of the product in response to orders submitted by users. This system has the important advantage of allowing the celebrity to donate a portion of their fees to the charity of their choice; a fact which may be included in the final product to increase the goodwill towards the product, the visibility of the charity as well as enhance the stature of the celebrity making the donation.

In addition, the invention solves the problem of computer security with respect to a device being used by a celebrity. An ordinary PC running Windows® connected to the Internet can be hacked and a celebrity computer is a tempting device both from the potential of personal information getting out, as well as access to sensitive financial information, not to mention the potential for identity theft. Therefore this invention includes a system to be used by the celebrity which is very simple, highly secure, and provides high-quality video results.

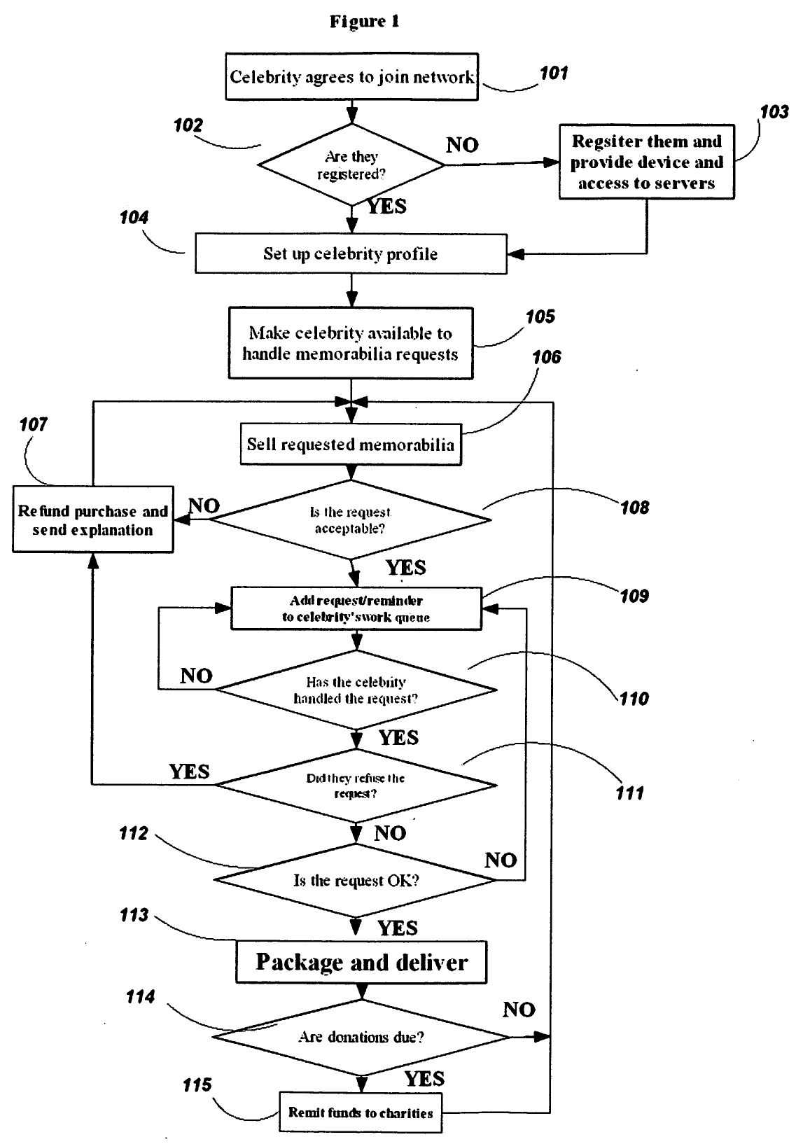

Turning now to FIG. 1, the first step is getting a celebrity to join the network (101). We check if they are already registered, which they might be if they joined earlier, left, and are returning (102). If they aren't we register them with the system and assign them a memorabilia producing device and password which authenticate them to the device and our servers, as well as helping them manage requests and fulfill orders for video greetings (103).

We then set up their profile (104), and determine what types of memorabilia requests the celebrity would accept. Singers might accept singing small songs (like ‘happy birthday’), sports stars might accept signing jerseys in addition to video requests, etc. In addition, the celebrity may nominate a charity to be a beneficiary of some of their sales, and can indicate the charity or charities as well as a fixed amount, percentage, etc. In addition, the celebrity can specify their level of tolerance for obscene or ‘off-color’ requests. For example the tolerance between a ‘gansta rap’ artist is likely to differ from a gospel singer. Likewise a star from adult movies will have different criteria than a sports anchor person, most of the time. This determination is done in consultation with the celebrity, and as such may vary according to their wishes, plus common sense. This allows the system to pre-screen the requests so as not to offend the celebrity. In addition, we record the credentials for posting to any video blog site they may have so that they can use the device to easily post to their video blog. This is simply an indication of the type of information which we would store in the celebrity's profile, and is by no means exhaustive.

We then add that celebrity to our inventory of celebrities available to produce associated customized memorabilia on demand (105). We then accept sales of memorabilia to be produced by a given celebrity, for example, a personalized birthday greeting video (106). The incoming request, which may include associated customization information, is reviewed for acceptability according to the parameters covered in (104), plus making sure no illegal, or disturbing requests get through (108). If the request is not acceptable, the purchase price is refunded, and a message is sent to the purchaser with details of the refusal (107). In an alternative embodiment, the payment may be effectuated once the request has been accepted.

If the request is acceptable, it is added to the celebrity's work queue which is a list of memorabilia requests to be fulfilled (109). We periodically check whether the celebrity has handled the request, within a predetermined period of time, if they haven't we send a reminder (110). This time can be determined in conjunction with the celebrity who can, depending on their schedule, give an idea of how long a request could take. In addition, the reminder could be sent based on the historical average time it takes that celebrity to process a request, or some similar calculation; this information could then be provided to the user at the time of purchase to indicate when they should expect delivery of their item. The availability of this information at the time of sale is important since celebrities who provide or promise a faster turn around are more likely to sell memorabilia than those who take months to handle a request.

Once the celebrity handles the request, we check whether they refused it (111). This is because celebrities may refuse to handle a request for whatever reason they deem sufficient. If they refused the request, the purchaser gets a refund and a message (107). If the celebrity hasn't refused the request, then it's been fulfilled. Although in the disclosed illustrative embodiment the method of handling the work queue is via the device the celebrities are provided (103), the above-described steps may be performed manually if needed. In addition, although the delivery method used in the illustrative embodiment is electronic delivery, it is also possible that delivery of memorabilia be done physically, i.e. an audio or a video greeting on DVD delivered by mail.

We then check to make sure the memorabilia is as requested and of a suitable quality (112). Note that this is an important step as it serves as a safeguard against possible mishaps by our celebrity—for example, handling memorabilia requests while grossly intoxicated, or performing some obscene acts or gestures while fulfilling the memorabilia request. It is essential that this system protect the celebrities as much as possible, even from themselves. Note that this determination takes into account the parameters set in their profile (104), plus common sense. If the memorabilia is correct, and of an acceptable quality, it is packaged and delivered (113). Packaging includes the steps of video post-production including, for example, adding titles and trailers, on screen graphics, audio track, best-of-videos, ads, sponsorships, etc., as well as sending, posting, burning to DVD, physically packing the memorabilia or otherwise preparing the memorabilia for delivery, and delivering it. If not, it's added back to the celebrity's work queue (109).

Finally, we check to see if any donations are due because of the sale (114), if so the donations are made (115), and the process continues with the next sale (106).

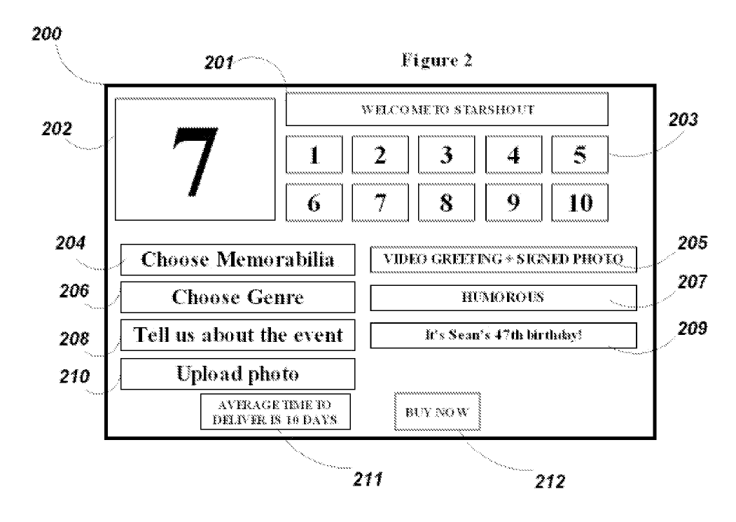

Referring now to FIG. 2, this is a block diagram of the system user interface for ordering the memorabilia. The screen is located at (200). The greeting is located at (201). An array of pictures of celebrities to choose from is located at (203), they are designated here as numbers from 1-10, although there may be more or they may be presented differently, the point is that there is a group of celebrities from which to select. In the future, they may be organized by genre, a list, presented as photographs, etc. Once a celebrity is selected, they picture or other indicia appear on screen at (202). In this example, our user has selected Celebrity 7.

The first thing the user needs to do is to select what kind of memorabilia (204) they would like to purchase. They can select from a list at (205). In this case, the user has indicated they'd like an audio or video greeting and a signed photograph. The memorabilia may differ for each celebrity, for example, singers may offer to sing songs, athletes may offer to sell jerseys and do video greetings, news anchors may offer to do ‘breaking news stories’, etc. Note that the method for selecting the memorabilia may be whatever is most appropriate for the system being used and the memorabilia being offered, and is not limited to a single box onscreen.

Next, the genre (206) is selected from a list at (207). Likewise, the genre may differ with the celebrity—our user has selected ‘humorous’; that they'd like the greeting to be funny. Other genres would be ‘sexy’, ‘serious’, ‘sincere’, ‘breaking news’, ‘sports report’, etc. The list of genres will correspond somewhat to the celebrity; the list here is by no means complete, it can be expanded to whatever types the celebrity is comfortable with, and likewise the means by which the selection is made can vary. In addition, the genre is not an absolute requirement, it's more of a suggestion to the celebrity; in other words they may not be able to be funny on demand.

Next we need to know about the event (208), the user can either write in the details or choose from a selection (209); in this case it's “Sean's 47^{th} birthday”, and the user is asked to upload a photo (210). The system displays the average time it takes the celebrity to deliver the memorabilia (211), which will vary from celebrity to celebrity, depending on their availability and propensity for working with the system. Finally, when the user has made all their selections, they can press the “buy now” button (212) to complete the purchase. They would then be taken to another screen to enter payment and delivery details appropriate to the device being used, the country they're from, and the payment and delivery options available.

The important elements here are that the user has a certain amount of latitude in asking the celebrity to produce the memorabilia, and the celebrity has a certain amount of latitude in fulfilling the request. Especially in the case of video greetings, by including a picture of the person receiving the greeting it allows a more sincere and personal reply from the celebrity, since they can see who they're talking to, and know what the occasion is. Including the uploaded photo, or other multimedia, in the final greeting results in an intense level of customization or personalization. Imagine a local news anchor reporting on “Sean's 47^{th} birthday” as a terrible crisis, with a picture of Sean in the background, or a the latest finalist from American Idol® singing “Happy Birthday” to Sean, again with a picture of Sean in the background.

In the illustrative embodiment, the interface is an online web interface using a computer connected to the internet, although any method of getting the required data into the order system would be acceptable. Likewise the selections may be expanded as needed, and the methods of selecting and data entry may vary. Indeed, this application could be running on a mobile device of some sort or entered via a system connected to a user's television, or simply by phone, or even by ground mail or catalogue.

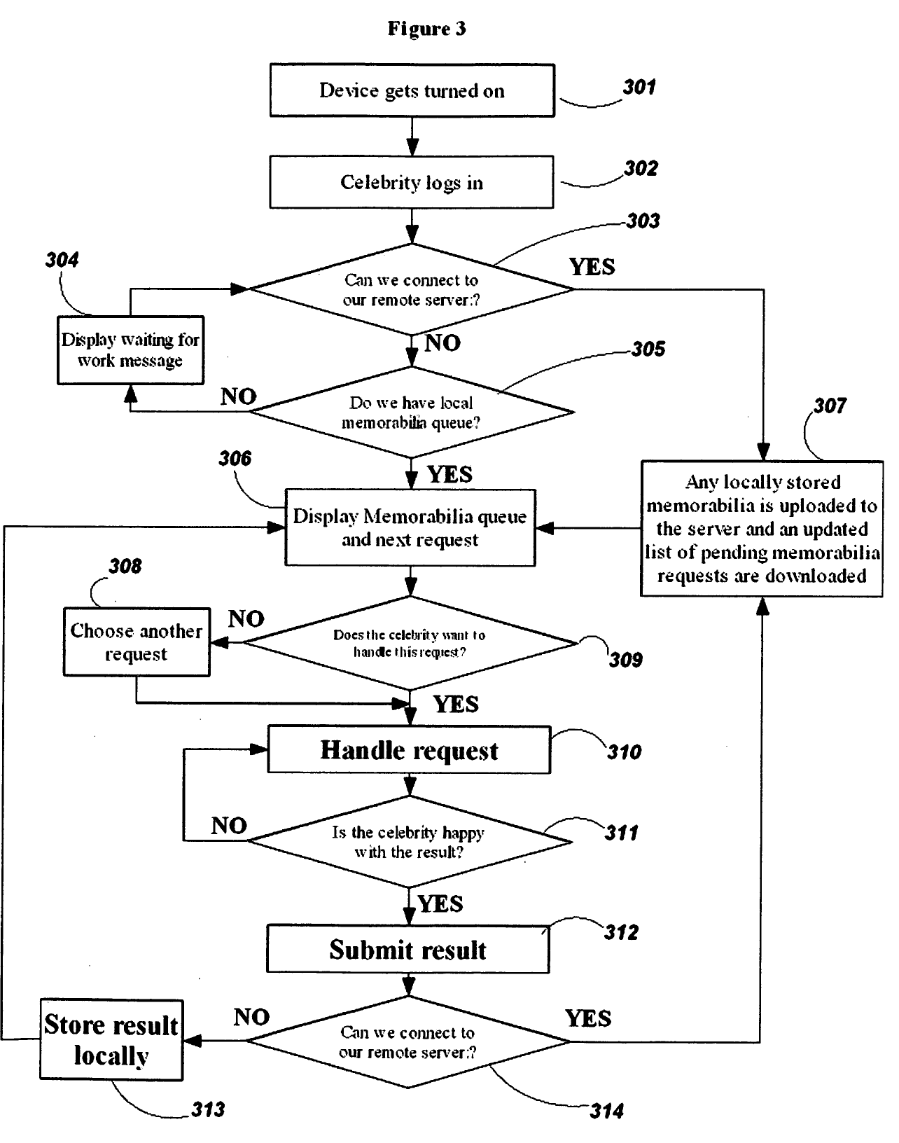

Turning now to FIG. 3, this is a flowchart showing how the memorabilia producing device works. In the illustrative embodiment, the device is in the form of an internet connected PC with local storage, a USB key or similar removable media for physical authentication and storage, plus an attached camera capable of producing high quality video, controlled by a touch screen. It is to be understood that the camera may be provided with an integrated or remote microphone. There are three (3) main reasons for using such a device. The first is that having a dedicated device will allow the celebrity to record high quality video messages to local storage. This means they can create video greetings even when they are not connected to a network, for example when athletes are on the road. Next, a dedicated device means we can completely control security, and make sure that this device only talks to our servers and is used exclusively with our application. This ensures that the celebrity's personal computers, with all their sensitive information, cannot be affected by us at all, even if we share their network connection. The third reason is that this single purpose device can be made extremely simple to operate, especially with a touch screen. Of course, although we are mentioning video, we are not limited to simple video, any multimedia can be used, and any memorabilia requests can be managed including but not limited to simple autographs, signed pictures, physical items, personal items, etc. And although we have provided an illustrative embodiment, any device capable of capturing video and running our software application, present and future, would be feasible.

The device gets turned on (301), and the celebrity logs in (302). The login could be handled in a number of ways, but in the illustrative embodiment it is a two (2) factor system, a password or personal identification number (PIN) combined with a physical device which must be present for the system to operate. A USB-based device with local storage would work well since the device could also be used to securely store unsent memorabilia. This set up has the additional benefit of allowing all user-specific information to be stored on a removable hardware device. This would allow multiple users to use the same physical device just by inserting their hardware key and entering their PIN number. This allows the device to support “multiple celebrity” environments such as those associated with sports teams, i.e. locker rooms and team buses, or for the anchors from local TV stations, or by the cast of a TV program or network. The important element here is not the type of hardware device selected, but the fact that it is removable, and has sufficient local storage to store the celebrity's details leaving nothing personal on the device itself. Also note that the physical key may be linked to the device, so that only certain keys work with a given device. So even if a key is stolen or lost, it's useless without the corresponding device.

The memorabilia producing device then checks to see if it can connect to our remote server (303). This could be via the internet, VPN, or modem. If we can't, we then check if there's a local memorabilia queue (305) which would have whatever the queue looked like the last time the celebrity was connected. If there isn't, there's not much to do but display a message (304) and wait. However, if we can connect to our remote server, which implies successful authentication, we send any locally stored memorabilia to the server, and get back an updated list of memorabilia requests (307). In the illustrative embodiment, this is a TCP based network connection. The memorabilia requests could be stored as individual files, named by the celebrity plus the request number, e.g. sharon-osborne.1234. In this manner the device and server could just exchange these files, requests, and fulfilled requests in a reasonably efficient manner. However, any mechanism that can synchronize the memorabilia queues, via database or otherwise, would be acceptable.

At this point, we display the memorabilia queue, or a portion thereof (306). The interface displays the next memorabilia request for the celebrity to create, and they can decide whether or not they want to handle it. (309). If they don't, they can choose another request to work on (308). They then handle the request (310). Note that handling the request includes being able to refuse to do it, which although somewhat counterintuitive, does result in the job being removed from the queue. However, the normal course of events would be that the celebrity records their video greeting, or other memorabilia request, and then reviews it to see if they're happy with the result (311). If they are, they submit it (312), if not, they go back and try it again (310). We then check to see if we can connect to our remote server again (314). If we can't, we just store the result locally, our preferred embodiment being stored and encrypted on the USB key, however any mode of storage would work, and if we can connect, the memorabilia is sent to the server, and an updated list retrieved therefrom (307). The software then displays the next memorabilia request (306) and we continue.

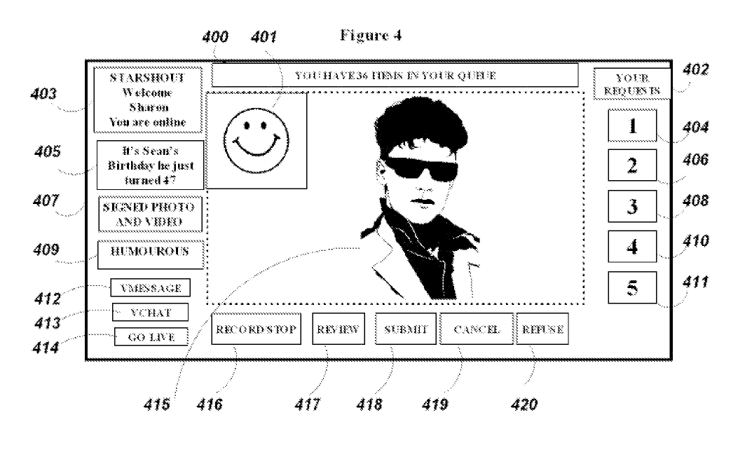

Finally, FIG. 4 shows a block diagram of the user interface of the memorabilia producing device described in FIG. 3. In the illustrative embodiment, a touch screen is used, but portable telephones, or a TV set provided the appropriate functionality was available, could also be used. The screen contains a status area (400) which provides status information like telling the celebrity about how many items are in their work queue. The system displays a welcome, the celebrity's name, in this case, Sharon, and connectivity information (403). A visual request queue (402) shows the next 5 elements in the queue (404, 406, 408, 410, 411). The number of elements displayed is arbitrary, the idea being to give the celebrity something of a choice in how to manage their queue of work. This is the most simple possibility, it is likely that more advanced queue management will be implemented which would allow the celebrity to sort jobs by type, i.e. all the birthday greetings, or by whether the buyers were male or female, or by genre, i.e. all the sincere greetings together, followed by all the humorous ones, etc.

The currently selected queue element is displayed at the top of the column (404), shown by the number 1. The queue moves up 404, then 406, 408, 410, 411 as the jobs are completed, however the celebrity can just select on any of the available jobs and that becomes the current task by indicating their selection; generally by clicking the area with a mouse or touching the area on a touch screen.

The occasion or other information about the current request is shown at (405), as well as the type of memorabilia requested, in this case a video and a signed photo (407). The genre of the request is displayed (409), in this case it's a request to be humorous. In addition, a picture of the recipient of the memorabilia is displayed (401).

Since the request is for a video, the celebrity's face will appear on screen (415), transmitted from the attached camera. Note that the recipient's picture will remain onscreen as well, as well as in the final product, in the same location (401). This serves several purposes; the first is that it makes it easier for the celebrity to make a video greeting to a person when you can see them, even if it's just a picture. In addition, including the recipient's photo in the final product results in a much more personalized and intimate celebrity experience. The final purpose of keeping the picture onscreen is that it visually masks off a part of the screen which serves as a reminder to the celebrity not use that part of the screen when recording their video greeting. As this is an illustrative embodiment, there may be other ways to display this same information which would work equally well. The essential element is that the celebrity can actually see who they're talking to, provided a photo or other multimedia is provided.

Once the celebrity decides to process a request for memorabilia, they use controls such as the buttons on the bottom of the screen (416-420). They can simply refuse the request by hitting the ‘refuse’ button (420). If they want to record a video message, they just hit the ‘record/stop’ button (416), once to start, once to stop. This controls the recording from the attached video camera. They can then play back the video they made by hitting the ‘review’ button (417), and if they're happy with the result, they can submit it using the ‘submit’ button (418), or just cancel the last effort by hitting the cancel button (419). The status area (400) will display the current status of the device, including whether it's recording, the status of a memorabilia submission, etc. Note that these buttons illustrate general functionality; it is understood that we may use a different combination of input styles from those presented herein.

Optionally, there may be three extra features buttons located in the bottom left-hand corner of the screen. For example, since the device already provides authentication for the celebrity as well as video recording, it is straightforward to add several useful and entertaining features to our device. The first is the message button (412). The celebrity can already create video messages using this device. Pushing this button lets them send the message as either an e-mail attachment, or allows them to post it to a video blog site. For email they would be prompted to enter the e-mail address to send the message to; for the blog we would just need to know where to post it. It is assumed that the blog information would be present on the server. For security reasons, the video messages would be processed in a manner similar to the video greetings, i.e. transmitted to our remote server where it would then be optionally post-processed and either emailed to the indicated recipient or posted to the celebrity's video blog.

The chat button (413) allows the celebrity to have a video chat with other celebrities on the network. In the future, this functionality may allow the celebrity to chat with others outside the network as well, using our remote server as a proxy. The reasoning here is that celebrities are a special group of people, and have a tendency to stick together. This just allows them to access each other if they so wish. This preference would be available from their profile.

The go live button (414) transmits the celebrity's video stream live to our servers, or to any another point which we may designate. This would allow the celebrity to appear remotely without the need for a crew to set up at their location. This functionality would have to be enabled from the server side, and would start when the celebrity pressed the button.

It is to be understood that the system user interface, servers and memorabilia producing device may communicate through various means, for example through a dedicated network, an Internet connection, Ethernet (broadband, high-speed), wireless WiFi, satellite connection, cellular or satellite network, etc.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

1. A method of fulfilling memorabilia requests, comprising the steps of:
(a) providing a list of celebrities, each celebrity having associated memorabilia;
(b) prompting a purchaser to request a memorabilia from one of the celebrities and to provide customization information;
(c) receiving the memorabilia request and the customization information;
(d) adding the memorabilia request to a work queue of the celebrity associated with the requested memorabilia;
(e) verifying if the requested memorabilia has been fulfilled by the associated celebrity using the provided customization information;
(f) if the memorabilia request has been fulfilled, delivering the requested memorabilia to the purchaser; and
(g) if the memorabilia request has not been fulfilled, returning to step (e).

2. A method of fulfilling memorabilia requests in accordance with claim 1, further comprising the steps of:
(e1) verifying if the fulfillment of the requested memorabilia has been refused by the associated celebrity; and
(f1) if the fulfillment of the requested memorabilia has been refused by the associated celebrity, informing the purchaser that the requested memorabilia has been refused;
and wherein step (g) returns to step (e) if the memorabilia request has not been fulfilled and the fulfillment of the requested memorabilia has not been refused.

3. A method of fulfilling memorabilia requests in accordance with claim 1, further comprising the steps of:
(c1) verifying if the request and the customization information are acceptable according to acceptability parameters; and
(c2) if the request and the customization information are not acceptable, informing the purchaser.

4. A method of fulfilling memorabilia requests in accordance with claim 3, further comprising the steps of:
(c1a) receiving payment for the requested memorabilia from the purchaser; and
(c2a) if the request and the customization information are not acceptable, informing the purchaser and refunding the payment.

5. A method of fulfilling memorabilia requests in accordance with claim 4, further comprising the step of:
(f1) making a donation to a specified charity.

6. A method of fulfilling memorabilia requests in accordance with claim 1, wherein step (g) further includes sending a reminder to the celebrity associated with the unfulfilled request after a predetermined time period.

7. A method of fulfilling memorabilia requests in accordance with claim 1, further comprising the step of:
(c3) providing the purchaser with a time estimate for the fulfillment of the memorabilia request.

8. A method of fulfilling memorabilia requests in accordance with claim 1, wherein step (f) further includes verifying if the fulfilled memorabilia request is of a suitable quality and returning the memorabilia request to the work queue of the celebrity if the fulfilled memorabilia request is not of a suitable quality.

9. A method of fulfilling memorabilia requests in accordance with claim 1, wherein the memorabilia is a customized multimedia.

10. A method of fulfilling memorabilia requests in accordance with claim 9, wherein step (f) further includes adding to the memorabilia at least one customization element selected from a group consisting of a title, a graphic, a video, an audio track, an ad and a sponsorship.

11. A method of fulfilling memorabilia requests in accordance with claim 9, wherein the multimedia is selected from a group consisting of a photograph, an audio greeting and a video greeting.

12. A method of fulfilling memorabilia requests in accordance with claim 1, further comprising the step of:
providing the celebrity with a memorabilia producing device for fulfilling memorabilia requests.

13. A method of fulfilling memorabilia requests in accordance with claim 12, wherein the memorabilia producing device comprises:
a camera;
a device user interface including:
a display, the display showing the memorabilia request work queue and images from the camera when activated; and
controls for selecting a current memorabilia request from the memorabilia request work queue, activating the camera for fulfilling the current memorabilia request and providing the fulfilled memorabilia request.

14. A method of fulfilling memorabilia requests in accordance with claim 13, wherein the device user interface is a touch-screen.

15. A method of fulfilling memorabilia requests in accordance with claim 13, wherein the camera includes a microphone.

16. A system for fulfilling memorabilia requests, comprising:
a system user interface configured so as to:
provide a list of celebrities, each celebrity having associated memorabilia;
prompt a purchaser to request a listed memorabilia and to provide customization information;
a memorabilia producing device having:
a camera;
a device user interface including:
a display, the display showing the memorabilia request work queue and images from the camera when activated; and
controls for selecting a current memorabilia request from the memorabilia request work queue, activating the camera for fulfilling the current memorabilia request and providing the fulfilled memorabilia request;
a remote server in communication with the system user interface and the memorabilia producing device, the remote server being so configured so as to:
(a) receive the memorabilia request and the customization information;
(b) add the memorabilia request to a work queue of the celebrity associated with the requested memorabilia;
(c) verify if the requested memorabilia has been fulfilled by the associated celebrity using the provided customization information;
(d) if the memorabilia request has been fulfilled, deliver the requested memorabilia to the purchaser; and
(e) if the memorabilia request has not been fulfilled, returning to step (c).

17. A system for fulfilling memorabilia requests in accordance with claim 16, wherein the device user interface is a touch-screen.

18. A system for fulfilling memorabilia requests in accordance with claim 16, wherein the camera includes a microphone.

19. A system for fulfilling memorabilia requests in accordance with claim 16, further comprising:
a removable media for use with the memorabilia producing device, the removable media providing a physical authentication associated with the celebrity;
wherein the removable media is required to operate the memorabilia producing device.

20. A system for fulfilling memorabilia requests in accordance with claim 19, wherein the removable media is a USB key.

21. A system for fulfilling memorabilia requests in accordance with claim 19, wherein the removable media contains information about the celebrity.

22. A system for fulfilling memorabilia requests in accordance with claim 21, wherein the information includes a password or a PIN and wherein the password or PIN is required to operate the memorabilia producing device.

23. A system for fulfilling memorabilia requests in accordance with claim 21, wherein the removable media can only be used with a specific memorabilia producing device.

24. A system for fulfilling memorabilia requests in accordance with claim 16, wherein the remote server is further so configured so as to:
(c1) verify if the fulfillment of the requested memorabilia has been refused by the associated celebrity; and
(d1) if the fulfillment of the requested memorabilia has been refused by the associated celebrity, inform the purchaser through the system user interface that the requested memorabilia has been refused;
and wherein step (e) returns to step (c) if the memorabilia request has not been fulfilled and the fulfillment of the requested memorabilia has not been refused.

25. A system for fulfilling memorabilia requests in accordance with claim 16, wherein the remote server is further so configured so as to:
(a1) verify if the request and the customization information are acceptable according to acceptability parameters; and
(a2) if the request and the customization information are not acceptable, inform the purchaser through the system user interface.

26. A system for fulfilling memorabilia requests in accordance with claim 25, wherein the remote server is further so configured so as to:
(a1a) receive payment for the requested memorabilia from the purchaser through the system user interface; and
(a2a) if the request and the customization information are not acceptable, informing the purchaser through the system user interface and refunding the payment.

27. A system for fulfilling memorabilia requests in accordance with claim 26, wherein the remote server is further so configured so as to:
(d1) provide a donation to a specified charity.

28. A system for fulfilling memorabilia requests in accordance with claim 16, wherein step (e) of the remote server further includes sending a reminder to the celebrity associated with the unfulfilled request through the memorabilia producing device after a predetermined time period.

29. A system for fulfilling memorabilia requests in accordance with claim 16, wherein the remote server is further so configured so as to:
(a3) provide the purchaser with a time estimate for the fulfillment of the memorabilia request through the system user interface.

30. A system for fulfilling memorabilia requests in accordance with claim 16, wherein step (d) of the remote server further includes verifying if the fulfilled memorabilia request is of a suitable quality and returning the memorabilia request to the work queue of the celebrity if the fulfilled memorabilia request is not of a suitable quality.

31. A system for fulfilling memorabilia requests in accordance with claim 16, wherein step (d) of the remote server further includes adding to the memorabilia at least one customization element selected from a group consisting of a title, a graphic, a video, an audio track, an ad and a sponsorship.

32. A method of fulfilling memorabilia requests, comprising the steps of:
(a) providing a list of celebrities, each celebrity having at least one associated memorabilia;
(b) prompting a purchaser to request from one of the celebrities the memorabilia associated with this one celebrity;
(c) receiving the memorabilia request;
(d) having the celebrity fulfill the memorabilia request; and
(e) delivering the requested memorabilia to the purchaser.

33. A method of fulfilling memorabilia requests in accordance with claim 32, wherein step (c) is performed at a remote location with respect to the prompting of step (b).
